(19) United States
(12) Patent Application Publication
(10) Pub. No.: US 2025/0252537 A1
(43) Pub. Date: Aug. 7, 2025

(54) ENHANCING IMAGES FROM A MOBILE DEVICE TO GIVE A PROFESSIONAL CAMERA EFFECT

(71) Applicant: DeepMind Technologies Limited, London (GB)

(72) Inventors: Ioannis Alexandros Assael, London (GB); Brendan Shillingford, London (GB)

(21) Appl. No.: 18/852,940

(22) PCT Filed: Feb. 24, 2023
(86) PCT No.: PCT/EP2023/054669

§ 371 Date: Sep. 30, 2024

(30) Foreign Application Priority Data
Mar. 31, 2022 (GR) 20220100286

(51) Int. Cl. G06T 5/60; H04N 23/63; H04N 23/80

(52) U.S. Cl. CPC G06T 5/60; H04N 23/631; H04N 23/815

(57) ABSTRACT

Systems and methods for processing an image from a mobile device so that it appears to have been captured by a camera with particular characteristics, for example a digital SLR camera with particular settings. The system uses a trained image enhancement neural network. The image enhancement neural network can be trained without needing to rely on pairs of images of the same scene; some training methods are described.

### BACKGROUND

This specification relates to enhancing an image from a mobile device, such as a smartphone, to allow a user to apply camera settings so that the image appears to have been captured by a camera with those settings.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes systems and methods for processing an image from a mobile device so that it appears to have been captured by a camera with particular characteristics, for example particular camera settings or a particular type of lens. Generally this is achieved using a machine learning model. More specifically it has been recognized that a neural network can be trained using data such as Exchangeable Image File (EXIF) data, that is typically captured when a digital camera is used to take a photograph, to enhance an image from a mobile device to give the appearance of an image captured by a professional camera.

Thus in one aspect there is described a computer-implemented method that may be implemented as computer programs on one or more computers in one or more locations, e.g. that may be implemented on a mobile device. The method involves capturing an image with a camera of a mobile device, e.g. a mobile phone, and obtaining, from a user interface of the mobile device, user input data defining a set of one or more specified characteristics of a digital camera. The set of one or more specified characteristics defines one or more characteristics of an exposure triangle of settings comprising an aperture setting, a shutter speed setting, and an ISO setting of the digital camera.

The method determines, from the user input data, a conditioning tensor that represents features of the one or more specified characteristics, and processes the image captured with the camera of the mobile device using a trained image enhancement neural network, whilst conditioned on the conditioning tensor, to generate an enhanced image having the appearance of an image captured by the digital camera with the specified characteristics. The enhanced image may be displayed to the user on the mobile device; stored for the mobile device, locally or remotely, or transmitted e.g. for someone else to view.

In implementations the image enhancement neural network has been trained whilst conditioned on conditioning tensors defined by camera-characterizing metadata e.g. Exchangeable Image File (EXIF) data.

The digital camera may be a “professional” camera, i.e. a digital camera that comprises a camera body and an interchangeable lens. For example the digital camera may be a DSLR (Digital Single Lens Reflex) camera or a mirrorless interchangeable-lens camera (MILC).

The method can be implemented in particular embodiments so as to realize various advantages. Counter-intuitively, implementations of the trained image enhancement neural network can produce very high quality images from mobile device cameras, e.g. smartphone cameras, surpassing the apparent physical limitations of the lens and sensor initially used to capture the image. Also, lens effects can be obtained that would otherwise be difficult to achieve without using a professional camera. For example, professional photographers can use the camera settings to control a degree of bokeh, but it is difficult to simulate this well using e.g. a depth-masked blur filter. As another example, implementations of the method facilitate applying multiple effects simultaneously, which is difficult to achieve through simulation.

It might be thought that such a neural network would need to be trained on pairs of the same image, one captured using a mobile device the other using a digital camera with particular settings. Whilst this could be done it would involve laboriously assembling a training dataset. However it has also been recognized that the image enhancement neural network can be trained without using such paired training data: In implementations the image enhancement neural network has been trained using an objective that does not require an image captured by a camera of the mobile device to be paired with a corresponding enhanced image.

One way in which the image enhancement neural network can be trained without using paired training data is by training the image enhancement neural network jointly with an image recovery neural network. In such approaches, during the training an image is processed sequentially using both the image enhancement neural network and the image recovery neural network to recreate a version of the image. Parameters of the image enhancement neural network parameters and of the image recovery neural network are updated to increase consistency between the image and the recreated version of the image, in particular based on gradients of an objective function dependent on a difference between the image and the recreated version of the image. This allows the image enhancement neural network to be trained using unpaired images.

A training data set for the system described herein comprises two sets of images, a set of source camera images captured by one or more source cameras of one or more mobile devices, and a set of digital camera images captured by one or more digital cameras. The digital camera images have camera-characterizing metadata, e.g. EXIF data that, for a digital camera image, defines one or more characteristics or settings of the camera body and lens used to capture the digital camera image.

The image enhancement neural network is trained to generate an enhanced image using a source camera image and whilst conditioned on the camera-characterizing metadata for generating the enhanced image. Thus the image enhancement neural network is trained to generate images that are from a distribution that corresponds to a distribution of the digital camera images. In some implementations the image enhancement neural network is configured and trained to process the source camera image to directly generate the enhanced image according to the camera-characterizing metadata. In other implementations the image enhancement neural network is trained to de-noise a noisy version of a digital camera image whilst conditioned on the camera-characterizing metadata for the digital camera image, and is then used to process the source camera image to generate the enhanced image according to the camera-characterizing metadata.

Similarly the image recovery neural network is trained to generate, from a digital camera image, a recovered image that has the appearance of a source camera image. Thus the image recovery neural network is trained to generate images that are from a distribution that corresponds to a distribution of the source camera images. In some implementations the image recovery neural network is configured and trained to directly process the digital camera image to generate the recovered image. In other implementations the image recovery neural network is trained to de-noise a noisy version of a source camera image, and is then used to process the digital camera image to generate the recovered image.

The methods and systems described in this specification can be implemented in particular embodiments so as to realize one or more of the following further advantages.

Whilst the cameras in smartphones have improved they are still limited by the lens and the amount of light it can capture. However in digital photography the size and type of the lens, the camera sensor response, and camera settings such as shutter speed, all play a significant role in the captured image that is obtained. Smartphones can simulate some effects of these settings, such as bokeh, but such simulations can be inaccurate and suffer from artefacts, such as edge artefacts resulting from poor resolution of the sensor or compounding errors where multiple image processing models are used. Implementations of the described systems can provide a trained image enhancement neural network that addresses these issues and that can produce enhanced images which simulate professional camera images with fewer artefacts and improved image quality, even surpassing the apparent physical limitations of the smartphone.

Training a neural network end-to-end using pairs of images of the same scene, captured by a mobile phone and by a digital, e.g. professional, camera, would involve the time-consuming collection of pairs of training images. Instead, however, the described techniques allow the image enhancement neural network to be trained using unpaired images, both source camera images from the mobile device and digital camera images, and this enables access to a much larger corpus of training data and hence to improved results.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example of a mobile device equipped with an image enhancement system.

FIGS. 2a and 2b show an example of a system for training an image enhancement neural network, and details of a particular example of the system of FIG. 2a.

FIG. 3 is a flow diagram of an example process for training for training an image enhancement neural network using the system of FIG. 2a.

FIG. 4 is a flow diagram of an example process for training an image enhancement neural network using the system of FIG. 2b.

FIG. 5 is a flow diagram of a further example process for training an image enhancement neural network.

FIG. 6 is a flow diagram of an example process for enhancing an image from a mobile device so that it appears to have been captured by a digital camera.

FIG. 7 is a flow diagram of an example process for using an image enhancement neural network to process an image.

Like reference numbers and designations in the various drawings indicate like elements.

### DETAILED DESCRIPTION

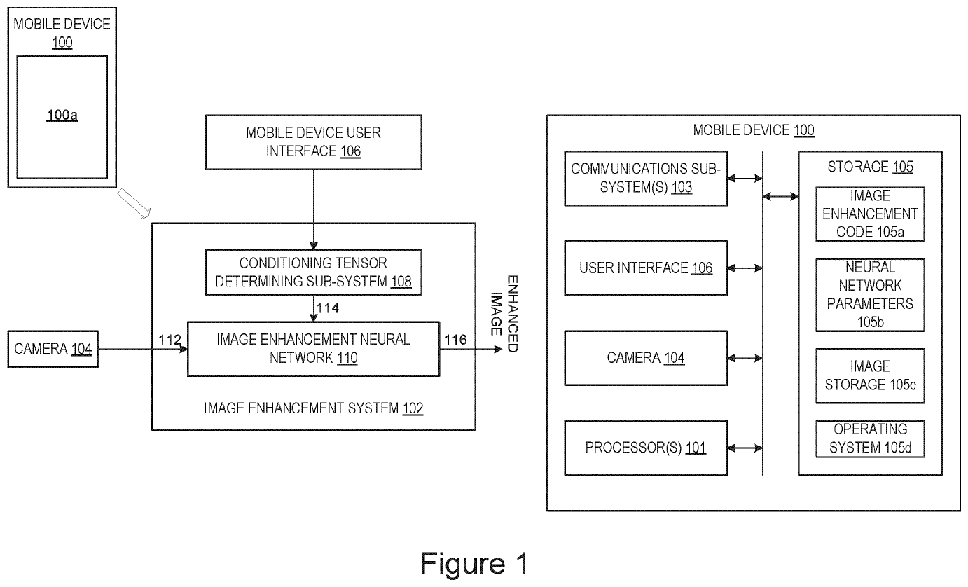

FIG. 1 shows an example of a mobile device 100 equipped with an image enhancement system 102 for enhancing an image captured by the mobile device, as described further later. The image enhancement system 102 may be implemented as one or more computer programs on one or more computers in one or more locations. More specifically the image enhancement system 102 may be implemented on the mobile device 100, or on a remote server, or partly on the mobile device 100 and partly on a remote server.

The mobile device 100 may be e.g. a mobile phone (cell phone) or smartphone, or a tablet computing device. The mobile device 100 includes a camera 104, e.g. a front-facing or rear-facing camera, as well as a display screen 100a, and provides a user interface 106. As some examples the user interface 106 may comprise a touch interface implemented e.g. by a touch sensitive display screen 100a, or a gesture interface implemented e.g. using camera 104, or a spoken word user interface implemented by capturing speech from a microphone of the mobile device (not shown).

The image enhancement system 102 includes an image enhancement neural network 110. The image enhancement neural network 110 has an image enhancement neural network input 112, and an image enhancement conditioning input 114 and is configured to process the image enhancement neural network input 112 whilst conditioned on the image enhancement conditioning input 114, and in accordance with current values of parameters e.g. weights, of the image enhancement neural network, to generate an image enhancement neural network output 116. More specifically image enhancement neural network 110 is configured to obtain the image enhancement neural network input 112 from the camera 104, and thus to process an image captured by the camera 104 to generate an enhanced image at the image enhancement neural network output 116. The image may be a still or moving image.

The image enhancement system 102 also includes a conditioning tensor determining sub-system 108. The image enhancement system 102 is configured to obtain from the user interface 106 user input data defining a set of one or more specified characteristics of a digital camera. The set of one or more specified characteristics defines one or more characteristics of an exposure triangle of settings comprising an aperture setting of the digital camera, a shutter speed setting of the digital camera, and an ISO setting of the digital camera (roughly equivalent to a film speed of the digital camera). The conditioning tensor determining sub-system 108 receives the user input data and processes the user input data, e.g. in accordance with parameters of the conditioning tensor determining sub-system, to generate a conditioning tensor that represents features of the one or more specified characteristics. As used herein a conditioning tensor is a tensor of numerical values. The conditioning tensor determining sub-system 108 may be implemented, e.g., using a learned encoding matrix or an embedding neural network, e.g. a feedforward neural network.

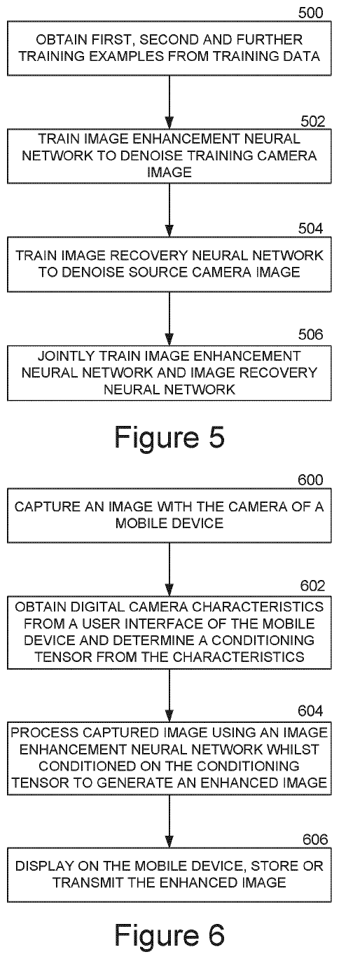

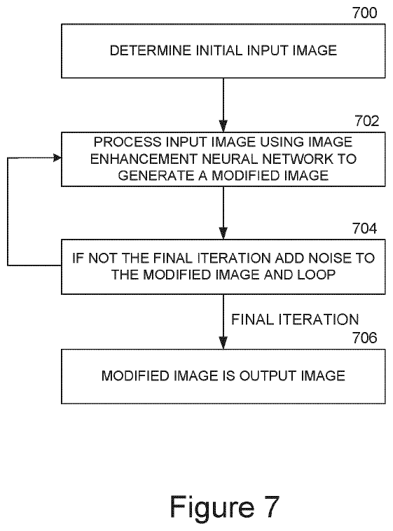

The image enhancement neural network 110 generates the enhanced image whilst conditioned on the conditioning tensor and thus, as described further later, the enhanced image is generated so that it has the appearance of an image captured by the digital camera with the specified characteristics. Examples of the operation of the image enhancement system 102, more specifically of the image enhancement neural network 110 are described later with reference to FIGS. 6 and 7.

FIG. 1 also shows a block diagram illustrating some of the components of an example mobile device 100. Thus the mobile device 100 includes one or more processors 101, non-volatile storage 105, and one or more communications sub-systems 103 for wireless communications with a computer or mobile phone network. These and the camera 104 are coupled together via a device bus. The storage 105 stores instructions and data that are used by processor(s) 101 to implement the image enhancement system 102. More specifically, as well as operating system code 105d, storage 105 also stores image enhancement code 105a to implement the conditioning tensor determining sub-system 108 and to implement image enhancement using the image enhancement neural network 110. Where the image enhancement neural network 110 is implemented on the mobile device storage 105 also stores parameters 105b of the image enhancement neural network 110. Storage 105 may also include image storage 105c, e.g. to store the capture image or the enhanced image.

In some implementations of the system the set of one or more specified characteristics defined by the user input data comprises at least two settings e.g. all three settings, of the exposure triangle of settings. In some implementations the specified characteristics may define that one of the aperture setting and the shutter speed setting takes priority over the other. The set of one or more specified characteristics may also include an exposure compensation setting to enable the enhanced image to be under- or over-exposed; or a flash setting to specify that the enhanced image gives the appearance of having been taken using flash illumination.

Where the digital camera is a camera comprising a camera body and an interchangeable lens implementations of the system also allow the user to specify characteristics of the camera that include a body type of the camera body or a lens type of the interchangeable lens, e.g. a make or model or the body type or lens type. The lens type may also or instead include a focal length of the lens, or a class of lens e.g. macro, fisheye, or telephoto. The set of one or more specified characteristics may specify that the camera is a digital SLR (DSLR) camera or MILC.

In some implementations the enhanced image has an image resolution that is higher than a resolution of the image captured with the camera of the mobile device, i.e. the implement the image enhancement system 102 can provide super-resolution imaging. In particular the training techniques described later enable the image enhancement neural network 110 to add realistic and faithful high resolution detail to an image captured at a lower resolution, which the image enhancement neural network can do because it has “seen” many different images. That is the trained image enhancement neural network may be used to add image details to the image captured with the camera of the mobile device. In implementations the additional details are i) generated at a resolution corresponding to a specified image resolution (which may be specified indirectly e.g. by specifying the camera body type), and ii) are consistent with image details at the resolution of the image captured with the mobile device that depict the content of the captured image.

In some implementations the user interface 106 may comprise a graphical user interface, e.g. implemented by the touch sensitive display screen 100a, that simulates the appearance of the digital camera with settings to allow the user to define the characteristics of the exposure triangle.

As described further later, in implementations the trained image enhancement neural network has been trained whilst conditioned on conditioning tensors defined by camera-characterizing metadata such as Exchangeable Image File (EXIF) data. In principle the image enhancement neural network may be trained end-to-end using pairs of images of the same scene, captured by a mobile device and by a digital, e.g. professional, camera, whilst conditioned on conditioning tensors defined, e.g., by EXIF data. The image from the mobile device may be provided as an input to the image enhancement neural network and the neural network may be trained by backpropagating gradients of an objective function dependent on a difference between an image of a scene generated by processing the captured image using the image enhancement neural network and an image of the same scene captured by the digital, e.g. professional, camera. In implementations, however, the trained image enhancement neural network is trained using (i.e. by backpropagating gradients of) an objective, e.g. a cycle consistency objective, that does not require an image captured by a camera of the mobile device to be paired with a corresponding enhanced image.

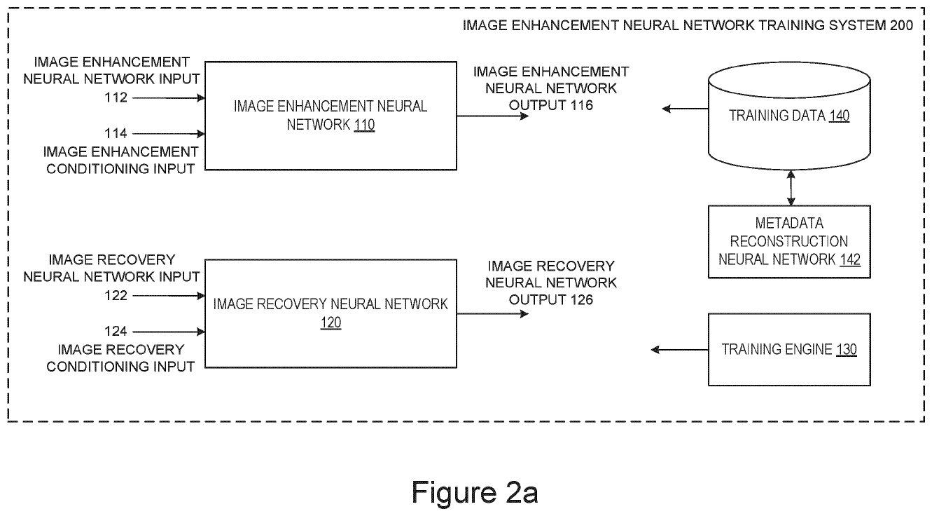

Thus FIG. 2a shows an example of an image enhancement neural network training system 200 which may be implemented as one or more computer programs on one or more computers in one or more locations. The system 200 may be used to train an image enhancement neural network 110 to enhance an image from a mobile device so that it gives the appearance of an image captured by a digital camera, such as a DSLR camera or MILC, with characteristics defined by an image conditioning input. The digital camera may be referred to as a target camera. The digital camera may be a professional camera; as used herein a professional camera is a camera with a camera body and an interchangeable lens. The image conditioning input may define characteristics of the digital camera, such as body type, lens type, and the like. As used herein “characteristics” of the digital camera also include settings of the digital camera such as an aperture setting, a shutter speed setting, an ISO setting (equivalent to a film speed setting), and the like.

In some other applications the system 200 may be used to the train image enhancement neural network 110 to process an image from a digital, e.g. DSLR camera or MILC, to give the appearance of an image captured with a particular lens or camera setting which is not available to the user, e.g. to add a “virtual lens” to a user's digital e.g. DSLR camera or MILC, or to virtually upgrade a user's digital e.g. DSLR camera or MILC to a high-end camera.

The processed image may be a monochrome or color image, and may be represented by a pixel value for each pixel of the image, e.g. an RGB (red green blue) pixel value. An image may also include additional information, e.g. an image depth map including pixel values that represent, for each pixel. An image may be a composite image derived from multiple sensors (cameras) e.g. with different resolutions, or an image may comprise multiple image channels e.g. with different spatial resolutions. The image may be a static image or a moving image. That is, as used herein references to an “image” include references an image that includes multiple video frames. For example the image enhancement neural network 110 may be configured to process a video input to generate an enhanced video output.

As previously described, the image enhancement neural network 110 processes both the image enhancement neural network input 112 and the image enhancement conditioning input 114 to generate the image enhancement neural network output 116. The image enhancement neural network output 116 may have a dimension of the image enhancement neural network input 112. It may define an image or it may define a correction to be applied to an image to enhance the image (and may have a dimension of the image to which the correction is to be applied). The image enhancement neural network input 112 is configured to receive a vector that defines an image, but as described later, sometimes this may be a noise vector that defines an image that is pure noise. The image enhancement conditioning input 114 may comprise camera-characterizing metadata as described below, in particular data defining one or more characteristics of the digital camera that the enhanced image to be generated appears to have been captured with.

The image enhancement neural network 110 has a plurality of image enhancement neural network parameters e.g. weights, that are adjusted by a training engine 130 during training of the system 200 to train image enhancement neural network 110 to perform an image enhancement function, as described later.

The image enhancement neural network training system 200 also includes an image recovery neural network 120 that has an image recovery neural network input 122, and is configured to process this input to generate an image recovery neural network output 126 that comprises a recovered image. In some implementations the image recovery neural network 120 also has an image recovery conditioning input 124, and the image recovery neural network 120 is configured to process the image recovery neural network input 122 whilst conditioned on the image recovery conditioning input 124 to generate the image recovery neural network output 126. The image recovery neural network output 126 may have a dimension of the image recovery neural network input 122. It may define an image or it may define a correction to be applied to an image to recover (or “de-enhance”) a version of image (and may have a dimension of the image to which the correction is to be applied). The image recovery neural network input 122 is configured to receive a vector that defines an image, but as described later, sometimes this may be a noise vector that defines an image that is pure noise.

The image recovery neural network 120 has a plurality of image recovery neural network parameters e.g. weights, that are adjusted by training engine 130 during training of the system 200, to train image recovery neural network 120 to perform an image recovery function, also as described later.

The image enhancement neural network 110 and the image recovery neural network 120 may have any neural network architecture that can accept an image input and process this to provide an image output. In general they may have any appropriate types of neural network layers, e.g., fully-connected layers, attention-layers, convolutional layers, and so forth, in any appropriate numbers, e.g., 1-100 layers, and connected in any appropriate configuration, e.g., as a linear sequence of layers. For example image enhancement neural network 110 and the image recovery neural network 120 may each have a U-Net neural network architecture (O. Ronneberger et al., arXiv: 1505.04597), comprising multiple down-sampling, e.g. convolutional, “analysis” layers followed by multiple up-sampling, e.g. convolutional, “synthesis” layers, with skip connections between the analysis and synthesis layers, and optionally including one or more attention layers.

The conditioning may be applied at one or more or all of the layers of the image enhancement neural network 110 and the image recovery neural network 120. For example in some implementations the conditioning neural network input may be concatenated or summed with the neural network input or may provide an extra channel for the image input. In some implementations the conditioning neural network input may also or instead be applied at one or more intermediate layers. If it is necessary to match a dimension of the conditioning neural network input with that of a layer at which it is applied this may be done by encoding the conditioning neural network input with a learned encoding matrix.

The system 200 includes a data store holding training data 140. In implementations the training data comprises a set of source camera images captured by one or more source cameras, i.e. mobile device cameras. The training data 140 also includes a set of digital camera images captured by one or more digital cameras, e.g. DSLR or MILC cameras, and corresponding camera-characterizing metadata for each of the digital camera images. In some cases camera-characterizing metadata may also be available for some or all of the source camera images, even where these are from mobile device e.g. mobile phone cameras. Either or both of the source camera images and the digital camera images may include images from multiple sensors as previously described; or may comprise moving images i.e. video. An advantage of implementations of the system is that it does not require paired source camera and digital camera images i.e. two images of the same scene taken respectively with source and digital cameras.

The camera-characterizing metadata for a digital camera image defines one or more characteristics of the digital camera as it was used when capturing the image. For example the camera-characterizing metadata may comprise EXIF (Exchangeable Image File) data e.g. as defined in or compatible with JEITA standard version 1.x or version 2.x or later, e.g. in standard CP-3451C. The camera-characterizing metadata may define one or more of: a focal length of the lens; a type of lens, e.g. wide angle, zoom, or normal; lens aperture, e.g. f-number; exposure time; light source, e.g. flash, daylight, tungsten or fluorescent; sensor sensitivity, e.g. as an ISO speed rating; camera body type, e.g. camera make/model; or other information, e.g. scene type information, subject distance, subject brightness, image size, image resolution, degree of compression.

In some cases camera-characterizing metadata may be missing from some of the digital camera images. Thus implementations of the system may include a metadata reconstruction neural network 142, e.g. a convolutional neural network, trained to reconstruct missing camera-characterizing metadata for one or more of the digital camera images. This may be trained to predict missing camera-characterizing metadata using images where the desired camera-characterizing metadata is present. For example the metadata reconstruction neural network 142 may have an input comprising an image and partial camera-characterizing metadata, and may be configured to process the input to generate an output comprising additional camera-characterizing metadata, e.g. to provide complete camera-characterizing metadata for the image enhancement conditioning input 114 of the image enhancement neural network. The metadata reconstruction neural network 142 may be trained e.g. using digital camera images for which such complete camera-characterizing metadata is available, masking elements of the metadata to generate a training input. In some cases missing camera-characterizing metadata may be determined or estimated from a database e.g. the type of lens may be used to determine its focal length; or the “film sensitivity” may be retrieved from the database using the camera body make/model.

FIG. 2b shows one particular implementation of the image enhancement neural network training system 200 of FIG. 2a. This particular implementation includes a training image discriminator neural network 201 and a source image discriminator neural network 210.

The training image discriminator neural network 201 has a training image discriminator input 202 to receive a training image discriminator input image, and is configured to process the training image discriminator input image to generate a training image discriminator output 206 comprising a prediction of whether the training image discriminator input image is a real digital camera image rather than an enhanced source camera image. For example the training image discriminator output 206 may generate a value that represents a probability that the training image discriminator input image is a real digital camera image.

In some implementations the training image discriminator neural network 201 also has a training image discriminator conditioning input 204 and is configured to process the training image discriminator input image whilst conditioned on the training image discriminator conditioning input 204 to generate the training image discriminator output 206. For example, where the training image discriminator input image comprises an enhanced source camera image the training image discriminator conditioning input 204 may comprise camera-characterizing metadata used to condition the image enhancement neural network 110 when generating the enhanced source camera image. Where the training image discriminator input image comprises a digital camera image the training image discriminator conditioning input 204 may comprise the camera-characterizing metadata for the digital camera image. In general the camera-characterizing metadata for a digital camera image defines one or more characteristics of an exposure triangle of settings comprising an aperture setting, a shutter speed setting, and an ISO setting of the digital camera used to capture the image.

The training image discriminator neural network 201 has a plurality of training image discriminator neural network parameters e.g. weights, that are adjusted by training engine 130 during training of the system 200, to train the training image discriminator neural network to generate a correct prediction, as described later.

The source image discriminator neural network 210 has a source image discriminator input 212 to receive a source image discriminator input image, and is configured to process the source image discriminator input image to generate a source image discriminator output 216 comprising a prediction of whether the source image discriminator input image is a real source camera image rather than a source camera image recovered (i.e. generated) from a digital camera image. For example the source image discriminator output 216 may generate a value that represents a probability that the source image discriminator input image is a real source camera image.

In some implementations the source image discriminator neural network 210 also has a source image discriminator conditioning input 214 and is configured to process the source image discriminator input image whilst conditioned on the source image discriminator conditioning input 214 to generate the source image discriminator output 216. For example, where the source image discriminator input image comprises a recovered source camera image, i.e. one generated from a digital camera image, the source image discriminator conditioning input 204 may comprise the camera-characterizing metadata for the digital camera image. Where the source image discriminator input image comprises a source camera image the source image discriminator conditioning input 204 may comprise random camera-characterizing metadata or null camera-characterizing metadata or, where available, camera-characterizing metadata for the source camera image.

The source image discriminator neural network 210 has a plurality of source image discriminator neural network parameters e.g. weights, that are adjusted by training engine 130 during training of the system 200, to train the source image discriminator neural network to generate a correct prediction, as described later.

In the implementation of FIG. 2b the image enhancement neural network 110 receives a source camera image at the image enhancement neural network input 112, and camera-characterizing metadata for the source camera image at the image enhancement conditioning input 114. It is trained to generate an image enhancement neural network output 116 comprising an enhanced image that gives the appearance of an image captured by a camera with characteristics defined by the image enhancement conditioning input.

The image enhancement neural network input 112 uses the image enhancement conditioning input 114 to define the appearance of the enhanced image it generates. That is, in implementations the enhanced image has an appearance defined by camera characteristics according to camera-characterizing metadata provided to the image enhancement conditioning input 114 whilst the enhanced image is generated. Optionally stochasticity, i.e. noise, may be added when generating the enhanced image.

The image recovery neural network 120 receives a digital camera image, and optionally camera-characterizing metadata for the digital camera image, and is trained to generate an image recovery neural network output 126 comprising a recovered image that gives the appearance of an image captured by a source camera. Optionally stochasticity, e.g. noise, may be added when generating the recovered image.

The image recovery neural network 120, the training image discriminator neural network 201, and the source image discriminator neural network 210, do not need camera-characterizing metadata to perform their respective functions, but this data can help the neural networks to learn to “undo” the effects of the camera settings represented by the camera-characterizing metadata. In general conditioning one or more of the image recovery neural network 120, the training image discriminator neural network 201, and the source image discriminator neural network 210, on camera-characterizing metadata as described above can improve overall system performance e.g. reducing artefacts.

The training image discriminator neural network 201, and the source image discriminator neural network 210 may have any neural network architecture that can accept an image input and process this to provide a prediction output. In general they may have any appropriate types of neural network layers, e.g., fully-connected layers, attention-layers, convolutional layers, and so forth, in any appropriate numbers, e.g., 1-100 layers, and connected in any appropriate configuration, e.g., as a linear sequence of layers.

In some implementations the training image discriminator neural network 201 and/or the source image discriminator neural network 210 may each comprise two “virtual” discriminators, each configured to operate on different aspects of the input image. For example a first such virtual discriminator may operate on global image features whilst a second operates over local image patches.

Thus in some implementations the source (or training) image discriminator neural network comprises a first source (or training) image classifier and a second source (or training) image classifier. The first source (or training) image classifier is configured to process the source (or training) image discriminator input image to generate a first intermediate source (or training) image prediction of whether the source (or training) image discriminator input image is a real source (or training) camera image. The second source (or training) image classifier is configured to process each of a plurality of source (or training) image patches, i.e. image regions, that tile the source (or training) image discriminator input image to generate a second intermediate source (or training) image prediction of whether the source (or training) image discriminator input image is a real source (or training) camera image. The source (or training) image discriminator neural network may then combine the first intermediate source (or training) image prediction and the second intermediate source (or training) image prediction to generate the source (or training) image discriminator output, i.e. the prediction of whether the source (or training) image discriminator image input is a real source (or training) camera image.

In some implementations the training image discriminator neural network 201 and/or the source image discriminator neural network 210 may each comprise a self-attention mechanism. This can enable the discriminator neural networks to compare different parts of an image input, and to attend to those parts that are most relevant to compare. It can also facilitate efficient processing of high-resolution images, and video.

Thus in some implementations the source (or training) image discriminator neural network comprises one or more attention neural network layers each configured to apply a attention mechanism over an attention layer input to generate an attention layer output. The source (or training) image discriminator neural network is configured to process each of a plurality of source (or training) image patches, i.e. image regions, that tile the source (or training) image discriminator input image to generate a set of source image (or training) patch encodings or feature maps. The source (or training) image discriminator neural network is further configured to process the set of image patch encodings by applying the attention mechanism over the set of source (or training) image patch encodings to generate a set of transformed source (or training) image patch encodings. These may then be combined, e.g. using one or more further neural network layers such as an MLP (a multilayer perceptron), to generate the prediction of whether the source (or training) image discriminator image input is a real source (or training) camera image.

The patch encodings may be generated by processing the image patches using a learned embedding matrix or a shared feature encoder neural network, e.g. a convolutional neural network. Each patch encoding may then be combined with a 1D or 2D positional encoding representing a position of the image patch in the input image, e.g. by summing or concatenation the patch encoding and positional encoding. In implementations the positional encoding has the same dimensionality as the patch encoding and be learned or pre-defined. The attention mechanism may be configured to generate a query vector and a set of key-value vector pairs from the attention layer input and compute the attention layer output as a weighted sum of the values. The weight assigned to each value may be computed by a compatibility (similarity) function of the query with the each corresponding key, e.g. a dot product or scaled dot product compatibility (similarity). The query vector and the set of key-value vector pairs may be determined by respective learned matrices applied to the attention layer input. In implementations they are determined from the same attention layer input and the attention mechanism is a self-attention mechanism. In general the attention mechanism may be similar to that described in Ashish Vaswani et al., “Attention is all you need”, and in Dosovitskiy et al. arXiv: 2010.11929.

In another particular implementation of the image enhancement neural network training system 200 of FIG. 2a the image enhancement neural network 110 and the image recovery neural network 120 are de-noising neural networks. That is the image enhancement neural network 110 is trained to de-noise a noisy version of a digital camera image received by the image enhancement neural network input 112; and the image recovery neural network 120 is trained to de-noise a noisy version of a source camera image received by the image recovery neural network input 122.

In this particular implementation the image enhancement neural network input 112 is configured to receive an input image that, during training, comprises a noisy digital camera image, and the image enhancement conditioning input 114 is configured to receive camera-characterizing metadata for the input image, during training the camera-characterizing metadata for the noisy digital camera image. The image enhancement neural network output 116 may define either a correction to be applied to the input image to obtain a reduced-noise input image, or the image enhancement neural network output may be the reduced-noise input image. In either case the input image is processed iteratively, to gradually reduce the noise to generate an enhanced image.

After training the image enhancement neural network input 112 receives an input image to be processed and the image enhancement conditioning input 114 receives camera-characterizing metadata that defines characteristics of a digital camera so that the enhanced image generated by the image enhancement neural network input 112 has the appearance of an image captured by the digital camera.

The image recovery neural network 120 operates in a similar way, receiving a noisy source camera image during training to de-noise the noisy source camera image. The image enhancement neural network 110 and the image recovery neural network 120 are also applied sequentially to either a source camera image or a digital camera image, and trained to recreate a version of this image; then the noisy digital camera image or the noisy source camera image is replaced by the source camera image or the digital camera image respectively. This is explained in more detail below.

In this implementation the image enhancement neural network 110 and the image recovery neural network 120 may have the same architecture as previously described e.g. a U-Net neural network architecture.

In general in the implementations described herein, after the image enhancement neural network 110 and the image recovery neural network 120 have been trained by the image enhancement neural network training system 200 only the trained image enhancement neural network 110 is retained. This provides a neural network that is configured to process an image so that it appears to have been captured by a camera with particular characteristics i.e. those defined by image enhancement conditioning input 114.

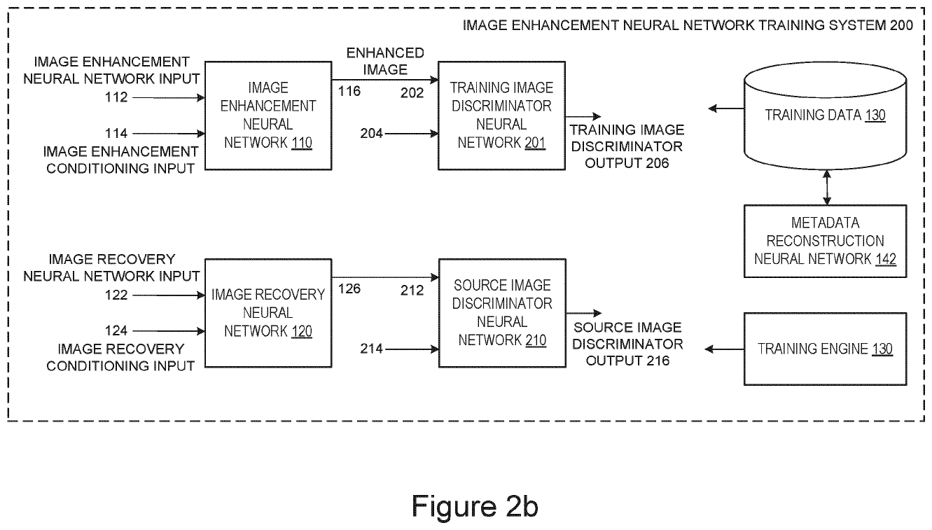

FIG. 3 is a flow diagram of an example process for using the system 200 of FIG. 2a to train the image enhancement neural network 110. The process of FIG. 3 is repeated multiple times during the training.

At step 300 the process obtains first, second, and further training examples by selecting these from the training data 140. The first training example comprises a selected source camera image, the second training example comprises a selected digital camera image, and the further training example comprises a further image that is selected from either one of the source camera images or from one of the digital camera images.

The process then trains the image enhancement neural network using one of the first and second training examples to generate a first enhanced image, whilst conditioned on camera-characterizing metadata for generating the first enhanced image (step 302).

Training the image enhancement neural network to generate the first enhanced image may comprise training the image enhancement neural network to generate an output that comprises the enhanced image. Or training the image enhancement neural network to generate the first enhanced image may comprise training the image enhancement neural network to generate an output that comprises a partially de-noised version of an input image, so that an enhanced (de-noised) image can be generated iteratively. Or training the image enhancement neural network to generate the first enhanced image may comprise training the image enhancement neural network to generate an output that represents noise in the input image that can be used to correct an input image to generate the enhanced image. Thus the process trains the image enhancement neural network so that after training it can be used to generate the first enhanced image directly (by outputting the enhanced image), or indirectly (e.g. by outputting image data for combining with an input image to provide an enhanced image).

In general the first enhanced image has the appearance of (is similar to) a digital camera image. That is it has the appearance of an image drawn from a distribution of the digital camera images. Depending upon the implementation it may, but need not, have the appearance of a specific digital camera image in the training data.

The process also trains the image recovery neural network using the other of the first and second training examples to generate a first recovered image (step 304). In general the first recovered image has the appearance of (is similar to) a source camera image. That is it has the appearance of an image drawn from a distribution of the source camera images. Depending upon the implementation it may, but need not, have the appearance of a specific source camera image in the training data.

Training the image recovery neural network to generate the first recovered image may comprise training to generate an output that comprises the recovered image, or training to generate an output that comprises a partially de-noised version of an input image, or training to generate an output that represents noise in the input image that can be used to correct an input image to generate the recovered image. The process trains the image recovery neural network so that after training it can be used to generate the first recovered image directly (by outputting the recovered image), or indirectly (e.g. by outputting image data for combining with an input image to provide a recovered image).

The process also jointly trains both the image enhancement neural network and the image recovery neural network using the further image (step 306). More specifically the further image is processed sequentially using first one then the other of the image enhancement and image recovery neural networks (in either order), to recreate a version of the further image. In some implementations processing using the image enhancement and image recovery neural networks may include a process of iteratively refining a generated image. The process then updates the image enhancement neural network parameters, and the image recovery neural network parameters, to increase consistency between the further image and the recreated version of the further image.

This step provides an additional constraint, so that as the image enhancement and image recovery neural networks are trained for performing their respective image enhancement and image recovery functions they are subject to an additional constraint. This additional constraint aims to ensure that when used to enhance an input image, the image enhancement neural network generates an image that has similar content to the input image, and similarly for the image recovery neural network.

In some implementations the image enhancement neural network parameters and the image recovery neural network parameters may be updated based on a gradient of an objective function dependent on a difference between the further image and the recreated version of the further image. The objective function may comprise, for example, an L1 loss or an L2 loss.

In some implementations the difference comprises the SSIM (Structural Similarity Index Measure) index for the recreated version of the further image calculated using the further image as a reference. This may comprise a weighted combination of a comparison of luminance, l, contrast, c, and structure, s, between one or more windows (aligned spatial patches) of the two images. For example for respective windows x and y, the SSIM may be determined from

$$l = \frac{2 {μ}_{x} {μ}_{y} + {c}_{1}}{{μ}_{x}^{2} + {μ}_{y}^{2} + {c}_{1}} , c = \frac{2 {σ}_{x} {σ}_{y} + {c}_{2}}{{σ}_{x}^{2} + {σ}_{y}^{2} + {c}_{2}} , s = \frac{{σ}_{xy} + {c}_{3}}{{σ}_{x} {σ}_{y} + {c}_{3}}$$

where μₓ and μ_{y} are the mean pixel intensity values over the windows, σₓ and σ_{y} are the variances, σ_{xy} is the covariance of x and y, and c₁, c₂, c₃ are constants. In some implementations the SSIM index may be a variant of SSIM such as a multiscale SSIM (MS-SSIM) index e.g. as described in Wang et al., “Multi-Scale Structural Similarity for Image Quality Assessment”, Proc. IEEE Asilomar Conference on Signals, Systems and Computers, 2004, pp. 1398-1402. In some other implementations a value of the objective function may be determined using a BM3D (Block-matching and 3D filtering) algorithm Danielyan et al. “ ” Cross-color BM3D filtering of noisy raw data” Intern. Workshop on Local and Non-Local Approximation in Image Processing, 2009, pp. 125-129. In some implementations the objective function may comprise a combination of two or more of the foregoing losses.

In implementations the gradient may be determined from one or a minibatch of training examples. General in the implementations described in this specification any gradient-based learning rule may be used. References to training a neural network based on the gradient of an objective function generally refers to backpropagating gradients of the objective function through the neural network being trained.

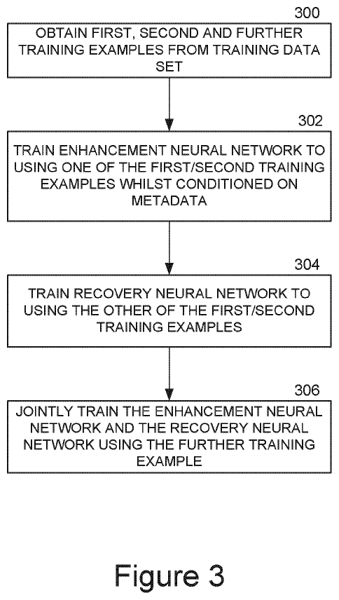

FIG. 4 is a flow diagram of an example process for using the implementation of the image enhancement neural network training system 200 shown in FIG. 2b to train the image enhancement neural network 110. Again, the process of FIG. 4 is repeated multiple times during the training.

At step 400 the process obtains first second and further training examples as previously described, as well as third and fourth training examples, by selecting these from the training data 140. The third training example comprises one of the source camera images, and the fourth training example comprises one of the digital camera images and, in implementations, its corresponding camera-characterizing metadata.

The third training example is processed by the source image discriminator neural network 210 to generate a first prediction of whether the third training example comprises a real source camera image or a synthetic source camera image (i.e. one generated using the image recovery neural network) (step 402). The source image discriminator neural network parameters are then updated to decrease an error in the first prediction (step 404).

The source image discriminator neural network parameters may be updated based on a gradient of an objective function dependent on D(x), where D(x) is a likelihood determined by the source image discriminator neural network that the third training example comprises a real source camera image, x. In particular the source image discriminator neural network parameters may be updated to maximize D(x) when the third training example comprises a real source camera image.

The source image discriminator neural network parameters may also be updated based on a gradient of an objective function dependent on D(G(y)), where G(y) is an image generated by the image recovery neural network 120. In particular the source image discriminator neural network parameters may be updated to minimize D(G(y)) when the source image discriminator neural network is provided with an image generated by the image recovery neural network 120, e.g. by processing a digital camera image, y, sampled from the training data, optionally whilst conditioned on camera-characterizing metadata for the digital camera image. Thus the source image discriminator neural network parameters may be updated based on a gradient of a combined objective function dependent on D(x)−D(G(y)) to maximize D(x)−D(G(y)). In another example combined objective function to be maximized may be dependent on log D(x)+log(1−D(G(y))). Optionally stochasticity may be added when using the image recovery neural network to generate G(z), e.g. using dropout or by adding noise to the input of the image recovery neural network 120.

The fourth training example is processed by the training image discriminator neural network 220 to generate a second prediction of whether the fourth training example is a real or synthetic digital camera image (step 406). In implementations, but not essentially, the digital camera image of the fourth training example is processed by the training image discriminator neural network whilst it is conditioned on the camera-characterizing metadata for the digital camera image. The training image discriminator neural network parameters are then updated to decrease an error in the second prediction (step 408).

The training image discriminator neural network parameters may be updated based on a gradient of an objective function dependent on D(x), where D(x) is a likelihood determined by the training image discriminator neural network that the fourth training example comprises a real digital camera image, x. In particular the training image discriminator neural network parameters may be updated to maximize D(x) when the fourth training example comprises a real digital camera image.

The training image discriminator neural network parameters may also be updated based on a gradient of an objective function dependent on D(G(y)), where G(y) is an image generated by the image enhancement neural network 110. In particular the training image discriminator neural network parameters may be updated to minimize D(G(y)) when the training image discriminator neural network is provided with an image generated by the image enhancement neural network 110, e.g. by processing a source camera image, y, sampled from the training data e.g. whilst conditioned on randomly selected camera-characterizing metadata.

Thus the training image discriminator neural network parameters may be updated based on a gradient of a combined objective function dependent on D(x)−D(G(z)) to maximize D(x)−D(G(z)). In another example combined objective function to be maximized may be dependent on log D(x)+log(1−D(G(z))). Optionally stochasticity may be added when using the image enhancement neural network to generate G(z), e.g. using dropout or by adding noise to the input of the image enhancement neural network 110.

In general, when the source image discriminator and training image discriminator neural network parameters are updated based on a gradient of an objective function determined by processing a real source or digital camera image the neural network parameters of the image enhancement and image recovery neural networks are not updated.

The image enhancement neural network 110 processes the selected source camera image of the first training example whilst conditioned on the camera-characterizing metadata for generating the first enhanced image, to generate the first enhanced image (step 410). The camera-characterizing metadata for generating the first enhanced image may be determined randomly e.g. by sampling the camera-characterizing metadata from a distribution.

The distribution may be a uniform distribution but in some implementations the method includes determining, i.e. modelling, a joint distribution over the characteristics defined by the camera-characterizing metadata in the training data set. Then camera-characterizing metadata for the image enhancement neural network 110 may be obtained by sampling from the joint distribution. For example, a neural network may be configured to implement a regression model and trained to model the joint probability distribution. Fitting a joint distribution is helpful as camera settings may be correlated and selecting combinations of settings that are out of the training distribution may make the task of the discriminators too easy, which may inhibit training of the generator neural networks 110, 120. Fitting a joint distribution may also facilitate interpolation between settings.

The first enhanced image is processed by the training image discriminator neural network 201, optionally whilst conditioned on the camera-characterizing metadata used to generate the first enhanced image, to generate a third prediction of whether the first enhanced image is a real digital camera image (step 412). The image enhancement neural network parameters are then updated to increase an error in the third prediction (step 414).

The image enhancement neural network parameters may be updated based on a gradient of an objective function dependent on D(G(x)), where G(x) is the first enhanced image generated by the image enhancement neural network 110. In particular the image enhancement neural network parameters are updated to maximize D(G(x)) or, in some implementations, to minimize log(1−D(G(x))).

As described above, each discriminator neural network may operate by processing an input image to generate a first intermediate prediction of whether the input image is real or synthetic e.g. based on processing the entire input image, and a second intermediate prediction of whether the input image is real or synthetic by processing image patches tiling the input image. These intermediate predictions may be combined to generate the prediction of whether the input image is real or synthetic. Also or instead each discriminator may operate by processing an input image by applying an attention mechanism over a plurality of image patches, specifically image patch encodings, to generate the prediction of whether the input image is real or synthetic.

The image recovery neural network 120 processes the selected digital camera image of the second training example, optionally whilst conditioned on the camera-characterizing metadata for the selected digital camera image, to generate the first recovered image (step 416). The first recovered image is processed by the source image discriminator neural network 210, optionally whilst conditioned on the camera-characterizing metadata for the selected digital camera image, to generate a fourth prediction of whether the first recovered image is a real source camera image (step 418). The image recovery neural network parameters are then updated to increase an error in the fourth prediction (step 420).

The image recovery neural network parameters may be updated based on a gradient of an objective function dependent on D(G(x)), where G(x) is the first recovered image generated by the image recovery neural network 120. In particular the image recovery neural network parameters are updated to maximize D(G(x)) or, in some implementations, to minimize log(1−D(G(x))).

As previously described the process also jointly trains both the image enhancement neural network and the image recovery neural network using the further image (step 422). Where the further image is obtained by selecting one of the source camera images camera-characterizing metadata for the further image may be obtained by random sampling as described above e.g. from a learned distribution. The further image is then processed using the image enhancement neural network whilst conditioned on the camera-characterizing metadata for the further image to generate an enhanced further image. The enhanced further image is then processed using the image recovery neural network, optionally whilst conditioned on the camera-characterizing metadata for the further image, to recreate the version of the further image.

The image enhancement neural network and the image recovery neural network are then trained to increase consistency between the further image and the recreated version of the further image as previously described, i.e. based on an objective function e.g. a loss that may be termed a cycle consistency loss, dependent on a difference between the further image and its recreated version. As training progresses the enhanced further image will start to have the appearance of an image from the distribution of digital camera images. In implementations the source camera image is an image captured by a mobile phone and the enhanced further image has the appearance of an image captured by a DSLR camera or MILC.

Where the further image is obtained by selecting one of the digital camera images, camera-characterizing metadata for the further image may comprise camera-characterizing metadata for the selected digital camera image obtained from the training data. The further image is then processed using the image recovery neural network to generate a recovered further image, and the recovered further image is processed using the image enhancement neural network whilst conditioned on the further image camera-characterizing metadata to recreate the version of the further image. The image enhancement neural network and the image recovery neural network are then trained as previously described.

In general the plurality of further training examples used to train system 200 includes further images obtained by selecting from both the source camera images and from the digital camera images.

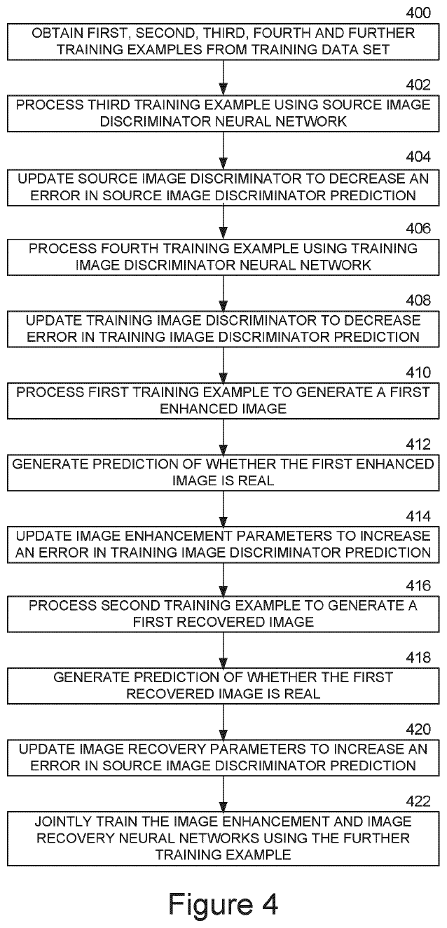

FIG. 5 is a flow diagram of an example process for using the system 200 shown in FIG. 2a to train the image enhancement neural network 110 when the image enhancement neural network 110 and the image recovery neural network 120 are de-noising neural networks. Again, the process of FIG. 5 is repeated multiple times during the training.

At step 500 the process obtains first, second, and further training examples as previously described, by selecting these from the training data 140. The first training example comprises a selected source camera image, the second training example comprises a selected digital camera image, and the further training example comprises a further image that is selected from either one of the source camera images or from one of the digital camera images. The process also obtains camera-characterizing metadata for the selected digital camera image.

The process then trains the image enhancement neural network 110, using the second training example, to de-noise a noisy version of the selected digital camera image whilst conditioned on the camera-characterizing metadata for the selected digital camera image (step 502). The process also trains the image recovery neural network 120, using the first training example, to de-noise a noisy version of the selected source camera image (step 504). Optionally camera-characterizing metadata for the selected source camera image may be obtained, e.g. by random selection as previously described or by obtaining this from the training data where available. Then the image recovery neural network 120 may be trained whilst conditioned on the camera-characterizing metadata for the selected source camera image. The process also jointly trains the image enhancement neural network 110 and the image recovery neural network 120 as described further below (step 506). The discriminator neural networks are not required.

Examples of this process can use the image enhancement neural network and the image recovery neural network to implement a type of de-noising diffusion model, but in inference the model is not used for de-noising as such. The de-noising diffusion model comprises a neural network that is trained with a de-noising objective so that it could be used iteratively to remove various levels of noise from an image.

Thus in implementations training the image enhancement neural network may involve generating a noisy version of the selected digital camera image and processing the noisy version of the selected digital camera image using the image enhancement neural network conditioned on the camera-characterizing metadata for the selected digital camera image, to generate an image enhancement neural network output. A value of an image enhancement objective function is then determined and the image enhancement neural network parameters are updated using a gradient of the image enhancement objective function with respect to the image enhancement neural network parameters. An example of guiding a de-noising process using additional data is described in Nichol et al. “GLIDE: Towards Photorealistic Image Generation and Editing with Text-Guided Diffusion Models” at section 2 (incorporated by reference); a similar approach may be used to condition on the camera-characterizing metadata, or on an encoding of this.

Generating the noisy version of the selected digital camera image may involve adding a noise vector, e, to the selected digital camera image, or otherwise corrupting the selected digital camera image. The noise vector may be sampled from a multivariate unit Gaussian distribution, ϵ˜N(0, I), and may have a dimension corresponding to that of the selected digital camera image. The noisy version of the selected digital camera image may be processed by the image enhancement neural network whilst further conditioned on a scalar noise level parameter, γ. The noise level parameter may be sampled from a distribution e.g. a piecewise uniform distribution. The image enhancement objective function may depend on a difference between the image enhancement neural network output and either i) the selected digital camera image or ii) the noise vector representing noise added to the selected digital camera image to generate the noisy version of the selected digital camera image. That is, the image enhancement neural network output 116 may be regressed to the added noise or to the original image.

In an example implementation the noisy version of the digital camera image may be or be derived from \sqrt{γ}y₀+\sqrt{1−γ}ϵ where y₀ denotes the selected digital camera image, and the image enhancement objective function may depend on ∥f(x, \sqrt{γ}y₀+\sqrt{1−γ}ϵ, γ)−ϵ∥ₚ^{p} where ∥·∥ₚ^{p} denotes a p-norm, f(·) denotes the image enhancement neural network output 116, and x denotes the camera-characterizing metadata for the selected digital camera image. In a variant the noise vector ϵ is replaced by the selected image y₀.

In a similar way, training the image recovery neural network may involve generating a noisy version of the selected source camera image and processing this using the image enhancement neural network to generate an image recovery neural network output. Then a value of an image recovery objective function is determined dependent on a difference between the image recovery neural network output and either i) the selected source camera image or ii) a noise vector representing noise added to the selected source camera image to generate the noisy version of the selected source camera image, and the image recovery neural network parameters are updated using a gradient of the image recovery objective function with respect to the image recovery neural network parameters. The image recovery objective function may correspond to the example the image enhancement objective function described above.

Although the image enhancement neural network is trained similarly to a de-noising diffusion model it is not used for de-noising: When the image enhancement neural network is used in inference it is provided with an input image has the appearance of a source camera image i.e. it resembles an image drawn from the distribution of source camera images, e.g. it is mobile phone-like. The image enhancement neural network iteratively processes the input image to generate an enhanced image that has the appearance of a corresponding digital camera image i.e. it resembles an image drawn from the distribution of digital camera images, e.g. it is DSLR-like or MILC-like. During this iterative processing the image enhancement neural network is conditioned on camera-characterizing metadata that defines the appearance of the enhanced image, more specifically that defines characteristics, e.g. settings, of a camera so that the enhanced image appears to have been captured by a camera having those particular characteristics e.g. those settings. During training the image enhancement neural network learns about the distribution of digital camera images (whilst conditioned on the corresponding camera-characterizing metadata), and can thus be used to iteratively process an input image so that it acquires properties of that distribution.

Similarly, although the image recovery neural network is trained similarly to a de-noising diffusion model it is not used for de-noising. In inference it is provided with an input image has the appearance of a digital camera image i.e. it resembles an image drawn from the distribution of digital camera images, and iteratively processes this to generate a recovered image that has the appearance of a corresponding source camera image, i.e. it resembles an image drawn from the distribution of source camera images.

Thus where, for example, the further image is obtained by selecting one of the source camera images, processing the further training example may comprise iteratively processing the further image using the image enhancement neural network whilst conditioned on camera-characterizing metadata for the further image to generate an enhanced image. As previously described the camera-characterizing metadata for the further image may be obtained by random sampling e.g. from a learned distribution or (where available) by retrieving this from the training data. Then the enhanced image is iteratively processed using the image recovery neural network to recreate the version of the further image. The image recovery neural network may also be (but need not be) conditioned on the camera-characterizing metadata for the further image i.e. on the data used to generate the enhanced image. The image enhancement neural network and the image recovery neural network are then trained jointly, by updating the image enhancement neural network parameters and the image recovery neural network parameters to increase consistency between the further image and the recreated version of the further image, as previously described.

In a particular example implementation using the image enhancement neural network to generate the enhanced image comprises determining an initial input image from the further image, and then updating the initial input image at each of a plurality of update iterations. Each update iteration comprises processing the input image using the image enhancement neural network whilst conditioned on the camera-characterizing metadata, x, for the further image to generate a modified input image. Each update iteration except for a final iteration also includes adding noise to the modified input image to generate an input image for the next iteration. For example with T iterations t=T, . . . , 1 and an initial input image y_{T}, the input image yₜ₋₁ at iteration t−1 may be determined from

$${y}_{t - 1} = \frac{1}{\sqrt{{α}_{t}}} ( {y}_{t} - \frac{1 - {α}_{t}}{\sqrt{1 - {α}_{t}}} f ( x , {y}_{t} , {γ}_{t} ) ) + \sqrt{1 - {α}_{t}} z where z \sim 𝒩 ( O , I ) ,$$

scalar parameters α_{1:T} are hyperparameters in the range [0, 1], f(·) is the image enhancement neural network output 116, and γₜ=Πᵢ₌₁^{t}αᵢ. Where, in a variant, during training the noise vector ϵ is replaced by the image y₀, the same approach can be used but with different hyperparameters.

The further image may be obtained by selecting one of the digital camera images, and the corresponding camera-characterizing metadata as the further image camera-characterizing metadata. Then processing the further training example may comprise iteratively processing the further image using the image recovery neural network, optionally conditioned on the further image camera-characterizing metadata, to generate a recovered enhanced image. This may employ the same particular example implementation as described above for the image enhancement neural network. The recovered image is then iteratively processed using the image enhancement neural network whilst conditioned on the further image camera-characterizing metadata to recreate the version of the further image. The image enhancement neural network and the image recovery neural network are then jointly trained to increase consistency between the further image and the recreated version of the further image as previously described. In general the further training examples include both source and digital camera images.

FIG. 6 is a flow diagram of an example process that may be implemented on a mobile device, for processing an image from the mobile device so that it appears to have been captured by a digital camera with particular characteristics. The processes uses the image enhancement neural network 110 of the image enhancement system 102 to process the captured image, after the neural network has been trained by the process of any of FIGS. 3-5. The steps of FIG. 6 may be implemented by a processor of the mobile device under control of stored instructions.

At step 600 an image is captured with a camera of the mobile device. The process also obtains, from a user interface of the mobile device, data defining a set of one or more specified characteristics of the digital camera, e.g. one or more characteristics of an exposure triangle of settings comprising an aperture setting, a shutter speed setting, and an ISO setting of the digital camera. This camera may be referred to as a target camera; it may but need not correspond to a camera that exists. The process then determines a value of a conditioning tensor defined by the one or more specified characteristics (step 602).

The image enhancement neural network 110 then processes the captured image whilst conditioned on the conditioning tensor to generate an enhanced image having the appearance of an image captured by the digital camera with the specified characteristics (step 604). The processing of the captured image by the image enhancement neural network 110 may be performed by the processor of the mobile device, or the processor of the mobile device may communicate with a remote server that implements the image enhancement neural network to process the captured image (in which case the enhanced image may be received back from the remote server). The enhanced image may be displayed on the mobile device, stored locally or remotely, or transmitted e.g. to another mobile device (step 606).

FIG. 7 is a flow diagram showing details of an example process for using the image enhancement neural network 110 to process the captured image to generate the enhanced image, after the image enhancement neural network has been trained by the process of FIG. 5. The steps of FIG. 7 may be performed by the processor of the mobile device or, e.g., by a remote server

At step 700 the process determines an initial input image for the image enhancement neural network 110 from the captured image. The initial input image may comprise the captured image or noise may be added e.g. to attenuate information that may be changed during the enhancement process. The image enhancement neural network then processes the input image as of the update iteration (e.g. the initial input image or a modified input image), whilst conditioned on the conditioning tensor, and optionally also conditioned on a value of the noise level parameter for the update iteration, to generate a modified input image (step 702), e.g. as described above. If a final update iteration has not yet been reached the process then adds noise to the modified input image, e.g. as also described above (step 704), and returns to step 702. If a final update iteration has been reached, e.g. after a defined number of iterations, T, no noise is added and the modified input image becomes the output image (step 706).

The image enhancement neural network 110 used in the example processes of FIG. 6 and FIG. 7 may be implemented on the mobile device, or on a server remote from the mobile device.

As previously mentioned, implementations of the systems and methods described herein may be used to process moving images i.e. video. Then one or more of the image enhancement neural network 110, the image recovery neural network 120, the training image discriminator neural network 201, and the source image discriminator neural network 210, may have 3D rather than 2D neural network inputs and outputs. Here a 3D input refers to a time sequence of image frames.

Processing within the image enhancement neural network 110, the image recovery neural network 120, the training image discriminator neural network 201, or the source image discriminator neural network 210, may similarly operate on data that has a time dimension as well as two space dimensions, e.g. by performing spatio-temporal convolutions or other processing. In some implementations one or both of the image enhancement neural network 110 and the image recovery neural network 120 are configured to generate a time sequence of frames, in which later frames are conditioned on earlier frames.

In some implementations one or both of the image enhancement neural network 110 and the image recovery neural network 120 have one or more one or more attention neural network layers, e.g. self-attention layers neural network layers. For example these may comprise two (or more) factorized self-attention neural network layers, i.e. configured so that each applies an attention mechanism over only a part of an input image sequence. For example a first factorized self-attention neural network layer may apply attention over just time-varying features of an input image sequence and one or more second factorized self-attention neural network layers may apply attention over just spatial features of the image frames of the input image sequence. That is, spatial feature maps may be generated from the image frames and processed separately to temporal feature maps generated from the input image sequence, reducing the memory requirements of the system.

Similarly one or both of the image discriminator neural networks may comprise a temporal discriminator neural network for discriminating based on temporal features of a series of image frames and a spatial neural discriminator network for discriminating based on spatial features of image frames. In implementations the spatial discriminator neural network may be configured to process image frames that have reduced temporal resolution (relative to a sequence of input image frames), the temporal discriminator neural network may be configured to process image frames that have reduced spatial resolution (relative to the sequence of input image frames), for computational efficiency.

When training the image enhancement neural network 110 and the image recovery neural network 120 for consistency when recreating the version of the further image, where the image is a moving image a temporal cycle consistency loss may be included e.g. as described in Dwibedi et al., arXiv: 1904.07846.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method, comprising:
capturing an image with a camera of a mobile device;
obtaining, from a user interface of the mobile device, user input data defining a set of one or more specified characteristics of a digital camera, wherein the set of one or more specified characteristics defines one or more characteristics of an exposure triangle of settings comprising an aperture setting, a shutter speed setting, and an ISO setting of the digital camera;
determining, from the user input data, a conditioning tensor that represents features of the one or more specified characteristics;
processing the image captured with the camera of the mobile device using a trained image enhancement neural network whilst conditioned on the conditioning tensor to generate an enhanced image having the appearance of an image captured by the digital camera with the specified characteristics; and
displaying the enhanced image on the mobile device for a user, storing the enhanced image, or transmitting the enhanced image.

2. The method of claim 1, wherein the set of one or more specified characteristics defined by the user input data comprises at least two settings of the exposure triangle of settings.

3. The method of claim 2, wherein the set of one or more specified characteristics defined by the user input data comprises the three settings of the exposure triangle of settings.

4. The method of claim 1, wherein the set of one or more specified characteristics defined by the user input data includes an exposure compensation setting to enable the enhanced image to be under- or over-exposed.

5. The method of claim 1, wherein the digital camera is a camera comprising a camera body and an interchangeable lens, and wherein the specified characteristics of the camera defined by the user input data include a body type of the camera body or a lens type of the interchangeable lens.

6. The method of claim 5, wherein the specified characteristics of the camera defined by the user input data comprise a make or model of the body type of the camera body, or of the lens type of the interchangeable lens.

7. The method of claim 5 wherein the specified characteristics of the camera defined by the user input data include a focal length of the interchangeable lens.

8. The method of claim 1, wherein the enhanced image has an image resolution that is higher than a resolution of the image captured with the camera of the mobile device; and wherein using the trained image enhancement neural network to generate the enhanced image includes using the trained image enhancement neural network to add image details to the image captured with the camera of the mobile device.

9. The method of claim 1, wherein the digital camera is a digital SLR (DSLR) camera.

10. The method of claim 1, wherein the digital camera is a mirrorless interchangeable-lens camera (MILC).

11. The method of claim 1, wherein the trained image enhancement neural network has been trained whilst conditioned on conditioning tensors defined by Exchangeable Image File (EXIF) data.

12. The method of claim 1, wherein the trained image enhancement neural network has been trained using an objective that does not require an image captured by a camera of the mobile device to be paired with a corresponding enhanced image.

13. The method of claim 1, comprising performing the processing using the trained image enhancement neural network on, or controlled by, the mobile device.

14. The method of claim 1, wherein the user interface is a graphical user interface that simulates the appearance of the digital camera with settings to allow the user to define the characteristics of the exposure triangle.

15. The method of claim 1, wherein processing the image comprises:
determining an initial input image from the captured image and updating the initial input image by, at each of a plurality of update iterations:
processing the input image as of the update iteration using the image enhancement neural network whilst conditioned on the conditioning tensor to generate a modified input image and
at each update iteration except a final update iteration, adding noise to the modified input image to generate an input image for a next update iteration.

16. A mobile device comprising at least one processor, and at least one storage device communicatively coupled to the at least one processor, wherein the at least one storage device stores instructions that, when executed by the at least one processor, causes the at least one processor to perform operations to:
capture an image with a camera of a mobile device;
obtain, from a user interface of the mobile device, user input data defining a set of one or more specified characteristics of a digital camera, wherein the set of one or more specified characteristics defines one or more characteristics of an exposure triangle of settings comprising an aperture setting, a shutter speed setting, and an ISO setting of the digital camera;
determine, from the user input data, a conditioning tensor that represents features of the one or more specified characteristics;
process the image captured with the camera of the mobile device using a trained image enhancement neural network whilst conditioned on the conditioning tensor to generate an enhanced image having the appearance of an image captured by the digital camera with the specified characteristics; and
display the enhanced image on the mobile device for a user, store the enhanced image, or transmit the enhanced image.

17. The mobile device of claim 16, wherein processing the image captured with the camera of the mobile device using the trained image enhancement neural network comprises:
determining an initial input image from the captured image, and updating the initial input image by, at each of a plurality of update iterations:
processing the input image as of the update iteration using the image enhancement neural network whilst conditioned on the conditioning tensor to generate a modified input image; and
at each update iteration except a final update iteration, adding noise to the modified input image to generate an input image for a next update iteration.

18. A computer-implemented method of training an image enhancement neural network to provide photographic images, wherein the image enhancement neural network has a plurality of image enhancement neural network parameters and is configured to receive an input image from a mobile device and to process the input image dependent on an image enhancement conditioning input to generate an enhanced image that gives the appearance of an image captured by a digital camera with characteristics defined by the image enhancement conditioning input, the method comprising:
for each of a plurality of first, second, and further training examples:
obtaining the first, second, and further training examples from a training data set comprising a set of source camera images captured by one or more source cameras of one or mobile devices, a set of digital camera images captured by one or more digital cameras, and camera-characterizing metadata for each of the digital camera images, wherein the camera-characterizing metadata for a digital camera image defines one or more characteristics of an exposure triangle of settings comprising an aperture setting, a shutter speed setting, and an ISO setting of the digital camera used to capture the image,
wherein the first training example comprises a selected source camera image, the second training example comprises a selected digital camera image, and the further training example comprises a further image that is either one of the source camera images or one of the digital camera images;
training the image enhancement neural network using one of the first and second training examples to generate a first enhanced image whilst conditioned on camera-characterizing metadata for generating the first enhanced image;
training an image recovery neural network having a plurality of image recovery neural network parameters, using the other of the first and second training examples, to generate a first recovered image; and
processing the further image sequentially using both the image enhancement neural network and the image recovery neural network to recreate a version of the further image, and updating the image enhancement neural network parameters and the image recovery neural network parameters to increase consistency between the further image and the recreated version of the further image.

19. The method of claim 18, wherein obtaining the training data set comprises, when camera-characterizing metadata is missing for a digital camera image, processing the digital camera image using a trained metadata reconstruction neural network to reconstruct the missing camera-characterizing metadata for the digital camera image.

20. The method of claim 18, wherein obtaining the camera-characterizing metadata for the further image comprises:
determining a joint distribution over the characteristics defined by the camera-characterizing metadata in the training data set, and
obtaining the camera-characterizing metadata for the further image by sampling the camera-characterizing metadata from the joint distribution.

21. The method of claim 18, wherein updating the image enhancement neural network parameters and the image recovery neural network parameters to increase a consistency between the further image and the recreated version of the further image comprises:
updating the image enhancement neural network parameters and the image recovery neural network parameters based on a gradient of an objective function dependent on a difference between the further image and the recreated version of the further image.

22. The method of claim 21 wherein the difference comprises an SSIM (Structural Similarity Index Measure) index for the recreated version of the further image calculated using the further image as a reference.

23. The method of claim 18, wherein the image enhancement neural network has a U-net architecture with skip connections.

24. The method of claim 18, wherein the source camera images comprise images captured by one or more mobile phones, and wherein the digital camera images comprise images captured by one or more DSLR or MILC cameras.

25. The method of claim 18, wherein the method further comprises, for each of a plurality of third and fourth training examples:
obtaining the third training example comprising one of the source camera images,
processing the third training example using a source image discriminator neural network having a plurality of source image discriminator neural network parameters, to generate a first prediction of whether the third training example is a real source camera image, and
updating the source image discriminator neural network parameters to decrease an error in the first prediction;
obtaining the fourth training example comprising one of the digital camera images and the corresponding camera-characterizing metadata,
processing the fourth training example using a training image discriminator neural network having a plurality of training image discriminator neural network parameters, whilst the training image discriminator neural network is conditioned on the camera-characterizing metadata for the digital camera image, to generate a second prediction of whether the fourth training example is a real digital camera image, and
updating the training image discriminator neural network parameters to decrease an error in the second prediction; the method further comprising
training the image enhancement neural network using the first training example by:
processing the selected source camera image using the image enhancement neural network, whilst conditioned on the camera-characterizing metadata for generating the first enhanced image, to generate the first enhanced image, and
processing the first enhanced image using the training image discriminator neural network conditioned on the camera-characterizing metadata for generating the first enhanced image to generate a third prediction of whether the first enhanced image is a real digital camera image, and
updating the image enhancement neural network parameters to increase an error in the third prediction; and
training the image recovery neural network using the second training example by:
processing the selected digital camera image using the image recovery neural network to generate the first recovered image, and
processing the first recovered image using the source image discriminator neural network to generate a fourth prediction of whether the first recovered image is a real source camera image, and
updating the image recovery neural network parameters to increase an error in the fourth prediction.

26. The method of claim 25, wherein obtaining the second training example further comprises obtaining the camera-characterizing metadata for the selected digital camera image; the method further comprising:
processing the selected digital camera image using the image recovery neural network conditioned on the camera-characterizing metadata for the selected digital camera image.

27. The method of claim 25, wherein obtaining the further training example comprises selecting one of the source camera images to obtain the further image, and obtaining camera-characterizing metadata for the further image; and wherein
processing the further training example comprises:
processing the further image using the image enhancement neural network whilst conditioned on the camera-characterizing metadata for the further image to generate an enhanced further image, and
processing the enhanced further image using the image recovery neural network to recreate the version of the further image.

28. The method of claim 25, wherein obtaining the further training example comprises selecting one of the digital camera images and the corresponding camera-characterizing metadata to obtain the further image and further image camera-characterizing metadata; and wherein
processing the further training example comprises:
processing the further image using the image recovery neural network to generate a recovered further image, and
processing the recovered further image using the image enhancement neural network whilst conditioned on the further image camera-characterizing metadata to recreate the version of the further image.

29. The method of claim 25,
wherein the source image discriminator neural network is configured to process a source image discriminator input image to generate a prediction of whether the source image discriminator image input is a real source camera image by:
processing the source image discriminator input image using a first source image classifier to generate a first intermediate source image prediction of whether the source image discriminator input image is a real source camera image;
processing each of a plurality of source image patches using a second source image classifier, wherein the plurality of source image patches tile the source image discriminator input image, to generate a second intermediate source image prediction of whether the source image discriminator input image is a real source camera image; and
combining the first intermediate source image prediction and the second intermediate source image prediction to generate the prediction of whether the source image discriminator image input is a real source camera image.

30. The method of claim 25,
wherein the training image discriminator neural network is configured to process a training image discriminator input image to generate a prediction of whether the training image discriminator image input is a real digital camera image by:
processing the training image discriminator input image using a first training image classifier to generate a first intermediate training image prediction of whether the training image discriminator input image is a real digital camera image;
processing each of a plurality of training image patches using a second training image classifier, wherein the plurality of training image patches tile the training image discriminator input image, to generate a second intermediate training image prediction of whether the training image discriminator input image is a real digital camera image; and
combining the first intermediate training image prediction and the second intermediate training image prediction to generate the prediction of whether the training image discriminator image input is a real digital camera image.

31-42. (canceled)
